(19) United States
(12) Patent Application Publication
(10) Pub. No.: US 2015/0167558 A1
(43) Pub. Date: Jun. 18, 2015

(54) METHOD OF REDUCING RATTLE NOISE OF VEHICLE

(71) Applicant: Hyundai Motor Company, Seoul (KR)

(72) Inventors: Jae Woong HWANG, Yongin-si (KR); Jin Hyun KIM, Seoul (KR); Heung Seok LEE, Seoul (KR); Seok Young SHIN, Gunpo-si (KR); Yong Wook JIN, Suwon-si (KR); Jang Won LEE, Yongin-si (KR)

(73) Assignee: Hyundai Motor Company, Seoul (KR)

(21) Appl. No.: 14/469,181

(22) Filed: Aug. 26, 2014

(30) Foreign Application Priority Data
Dec. 13, 2013 (KR) 10-2013-0155324

(51) Int. Cl. F02D 11/02; B60W 10/30; B60W 10/06

(52) U.S. Cl. CPC F02D 11/02; B60W 10/06; B60W 10/30

(57) ABSTRACT

A method of reducing rattle noise of a vehicle may include a coasting driving determination step of determining whether the vehicle is coasting, a fuel-in condition determination step of repeating the coasting driving determination step until a fuel-in condition is met when current RPM of an engine at a time at which it is determined that the vehicle is coasting is at least higher than fuel-in RPM of the engine, a minimum fuel-in step of performing a minimum fuel-in operation of supplying a minimum controllable unit of fuel when, at the fuel-in condition determination step, it is determined that the fuel-in condition is met, and a fuel-in repetition step of repeating the minimum fuel-in step a predetermined reference number of times within a range in which an angular acceleration amplitude increase rate of the engine does not exceed a predetermined reference increase rate by the minimum fuel-in operation.

### CROSS-REFERENCE(S) TO RELATED APPLICATION

The present application claims priority of Korean Patent Application Number 10-2013-0155324 filed on Dec. 13, 2013, the entire contents of which application is incorporated herein for all purposes by this reference.

### BACKGROUND OF THE INVENTION

1. Field of the Invention

The present invention relates generally to a method of reducing the rattle noise of a vehicle and, more particularly, to a method of reducing and preventing the rattle noise of a transmission that is generated by fuel-cut and fuel-in operations that cut off and resume the supply of fuel during the transition to the creep driving of a vehicle.

2. Description of Related Art

The term “creep driving” means that a vehicle maintains a driving state by itself in the state in which a driver does not step on an accelerator pedal when the vehicle is slowly running in a low gear position, such as a first or second gear position. In this state, an engine controller controls an engine so that the engine remains at the minimum revolutions per minute (RPM) in a minimum range in which the driving state of the vehicle can be maintained.

Meanwhile, in order to improve gas mileage, a vehicle performs a fuel-cut operation of cutting off the supply of fuel to an engine based on the conditions of the vehicle during coasting in which an accelerator pedal is not stepped on, and performs a fuel-in operation of supplying fuel to the engine again in a situation where it is necessary to maintain the running state of the vehicle because the RPM of the engine has decreased. Meanwhile, when the driver maintains the state of not stepping on the accelerator pedal after the fuel-cut operation has been performed, the creep driving of the vehicle is initiated.

When the RPM of the engine gradually decreases after the fuel-cut operation and then the vehicle performs creep driving, a fuel-in operation is performed. In this case, a problem arises in that rattle noise is generated by the fuel-in operation in the vehicle equipped with a manual transmission.

In other words, when the supply of the fuel to the engine is cut off by the fuel-cut operation and resumed by the fuel-in operation during the transition to the creep driving of the vehicle equipped with a manual transmission, the rattle noise is generated in the vehicle due to backlash that is generated among gears of the transmission while an operating state is being switched from a state in which reverse torque is applied to the engine by driving wheels during the fuel-cut operation to another state in which forward torque is applied to the engine during the fuel-in operation.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method of reducing the rattle noise of a vehicle, which is capable of, in a vehicle equipped with a manual transmission, reducing or preventing the rattle noise of a transmission when a fuel-in operation is performed during the transition to creep driving after a fuel-cut operation, thereby improving the noise characteristics of the vehicle and ultimately enhancing the marketability of the vehicle.

In an aspect of the present invention, a method of reducing rattle noise of a vehicle may include a coasting driving determination step of determining whether the vehicle is coasting, a fuel-in condition determination step of repeating the coasting driving determination step until a fuel-in condition is met when current revolutions per minute (RPM) of an engine at a time at which it is determined that the vehicle is coasting is at least higher than fuel-in RPM of the engine, a minimum fuel-in step of performing a minimum fuel-in operation of supplying a minimum controllable unit of fuel when, as a result of a determination at the fuel-in condition determination step, it is determined that the fuel-in condition is met, and a fuel-in repetition step of repeating the minimum fuel-in step a predetermined reference number of times within a range in which an angular acceleration amplitude increase rate of the engine is not made to exceed a predetermined reference increase rate by the minimum fuel-in operation.

The method may further include a fuel-in termination step of, after the minimum fuel-in step, terminating the minimum fuel-in operation when the angular acceleration amplitude increase rate of the engine exceeds the predetermined reference increase rate or when the fuel-in repetition step may have been performed, and a creep driving entry step of, after the fuel-in termination step, determining whether an accelerator pedal may have been stepped on, and entering a state of creep driving when it is determined that the accelerator pedal may have not been stepped on.

The fuel-in condition determination step is configured to, after performing a fuel-cut determination step of repeatedly determining whether a fuel-cut operation may have been performed when the current RPM of the engine exceeds fuel-cut RPM of the engine, repeatedly determine whether the fuel-in condition is met when it is determined that the fuel-cut operation may have been performed.

The creep driving entry step is performed when, it is determined that the current RPM of the engine is equal to or lower than the fuel-in RPM of the engine.

The method returns to the coasting driving determination step when it is determined at the creep driving entry step that the accelerator pedal may have been stepped on.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating a method of reducing the rattle noise of a vehicle according to an exemplary embodiment of the present invention.

FIG. 2 shows graphs illustrating the effect of rattle noise reduction according to the invention compared to the rattle noise in the prior art.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Reference now should be made to the drawings, throughout which the same reference numerals are used to designate the same or similar components.

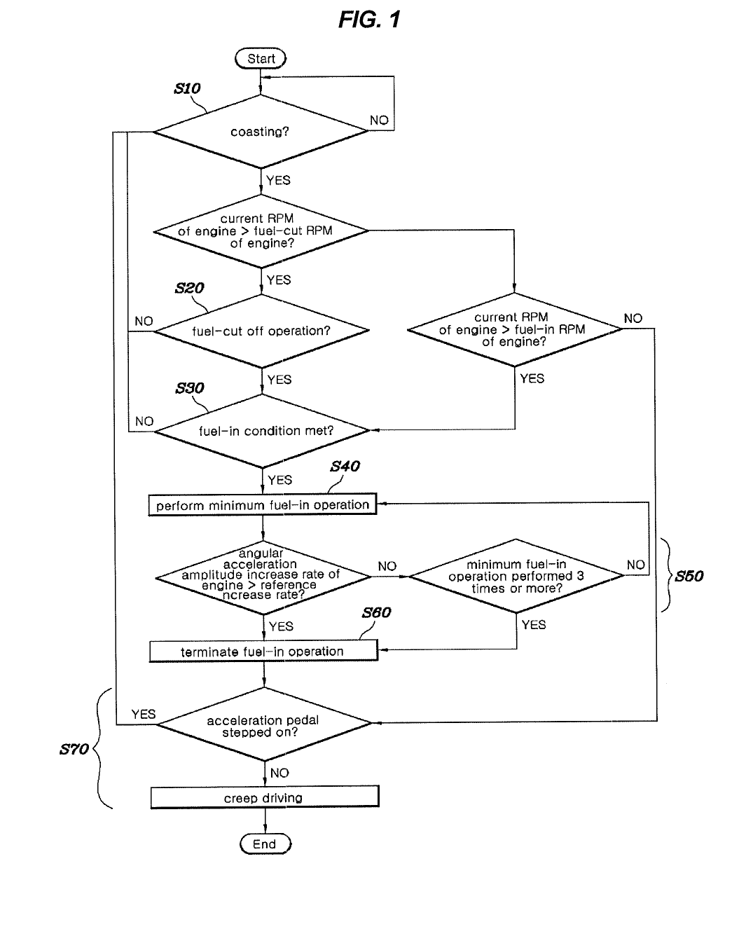

Referring to FIG. 1, a method of reducing the rattle noise of a vehicle according to an exemplary embodiment of the present invention is configured to include a coasting driving determination step S10 of determining whether a vehicle is coasting, a fuel-in condition determination step S30 of repeating the determination until the fuel-in condition is met if the current RPM of an engine at the time at which it is determined that the vehicle is coasting is at least higher than the fuel-in RPM of the engine, a minimum fuel-in step S40 of performing a minimum fuel-in operation of supplying a minimum controllable unit of fuel if, as a result of the determination at the fuel-in condition determination step S30, it is determined that the fuel-in condition is met, and a fuel-in repetition step S50 of repeating the minimum fuel-in step S40 a predetermined reference number of times within a range in which the angular acceleration amplitude increase rate of the engine is not made to exceed a predetermined reference increase rate by the minimum fuel-in operation.

Furthermore, the method of reducing the rattle noise of a vehicle according to the exemplary embodiment of the present invention may be configured to further include a fuel-in termination step S60 of, after the minimum fuel-in step S40, terminating the minimum fuel-in operation if the angular acceleration amplitude increase rate of the engine exceeds the predetermined reference increase rate or if the fuel-in repetition step S50 has been performed, and a creep driving entry step S70 of after the fuel-in termination step S60, determining whether an accelerator pedal has been stepped on, and entering the state of creep driving if it is determined that the accelerator pedal has not been stepped on.

In accordance with the method of reducing the rattle noise of a vehicle according to the exemplary embodiment of the present invention, when an operating state is changed from the fuel-cut operation to the fuel-in operation while a vehicle is coasting, the amount of the fuel to be supplied is limited to a minimum controllable unit amount and thus the supply of the fuel is resumed while avoiding a sudden change in engine torque, thereby preventing the generation of rattle noise attributable to the sudden change in engine torque during the fuel-in operation.

It will be apparent that the minimum controllable unit amount of fuel in the minimum fuel-in operation is usually smaller than the amount of fuel in the fuel-in operation of the prior art.

In this case, whether the torque fluctuation of the engine is excessive is determined based on whether the angular acceleration amplitude increase rate of the engine exceeds the predetermined reference increase rate. More specifically, for example, if the rate of the currently measured angular acceleration amplitude of the engine with respect to the average of the angular acceleration amplitudes of the engine for a few seconds is larger than the reference increase rate, it is determined that the torque fluctuation of the engine is excessive. In this case, the reference increase rate is a value (e.g., about 5%) that may be set by experiment or analysis.

Furthermore, although the reference number of times at the fuel-in repetition step S50 is illustrated as three in FIG. 1, it may be set to a different value by experiment or analysis.

In this embodiment, the fuel-in condition determination step S30 is configured to, after performing a fuel-cut determination step S20 of repeatedly determining whether a fuel-cut operation has been performed if the current RPM of the engine exceeds the fuel-cut RPM of the engine, repeatedly determine whether the fuel-in condition is met if it is determined that the fuel-cut operation has been performed.

Furthermore, in this embodiment, the creep driving entry step S70 is performed if, as a result of the determination at the fuel-in condition determination step S30, it is determined that the current RPM of the engine is equal to or lower than the fuel-in RPM of the engine.

That is, different control is performed depending on a range within which the current RPM of the engine falls at the time at which the coasting of the vehicle starts. Such ranges are classified into a highest case where the current RPM of the engine is higher than the fuel-cut RPM of the engine, an intermediate case where the current RPM of the engine is equal to or lower than the fuel-cut RPM of the engine and is higher than the fuel-in RPM of the engine, and a lowest case where the current RPM of the engine is equal to or lower than the fuel-in RPM of the engine. If the current RPM of the engine determined to correspond to the coasting of the vehicle is higher than the fuel-cut RPM of the engine, the fuel-cut condition determination step S20 is performed and then it is determined whether the fuel-in condition is met. If the current RPM of the engine corresponds to the intermediate case where the current RPM of the engine is equal to or lower than the fuel-cut RPM of the engine and is higher than the fuel-in RPM of the engine, it is immediately determined whether the fuel-in condition is met. If the current RPM of the engine is equal to or lower than the fuel-in RPM of the engine, the state of creep driving is immediately entered after the creep driving entry step S70 unless the accelerator pedal is stepped on, and thus the control of the vehicle is performed according to a conventional creep driving method.

If it is determined at the creep driving entry step S70 that the accelerator pedal has been stepped on, the process returns to the coasting driving determination step S10. Accordingly, the current process is terminated, and the coasting driving determination step is performed again.

As described above, in accordance with the present invention, when rattle noise is generated due to a sudden increase in engine torque because the fuel-cut operation is performed during the coasting of the vehicle and then the fuel-in operation is performed during the transition to creep driving, the minimum fuel-in step S40 of supplying a minimum controllable unit amount of fuel to the engine is performed at least once, thereby gradually increasing the torque of the engine and thus reducing or preventing the generation of rattle noise.

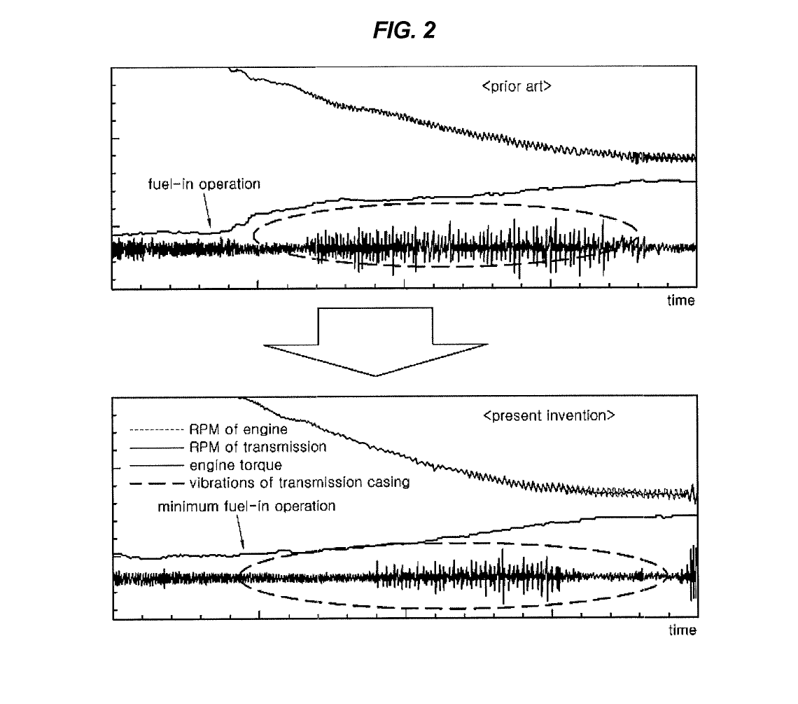

Referring to FIG. 2, in the prior art, engine torque is suddenly increased by a fuel-in operation in which a normal amount of fuel is supplied directly to the engine, and thus the vibration of a transmission casing, that is, the cause of rattle noise, is significantly generated. In contrast, in an exemplary embodiment of the present invention, the vibration of a transmission casing is significantly reduced because engine torque is gradually and smoothly increased by a fuel-in operation. See the dotted line portions of FIG. 2.

In accordance with the present invention, in a vehicle equipped with a manual transmission, it is possible to reduce or prevent the rattle noise of a transmission when a fuel-in operation is performed during the transition to creep driving after a fuel-cut operation, thereby improving the noise characteristics of the vehicle and ultimately enhancing the marketability of the vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of reducing rattle noise of a vehicle, comprising:
a coasting driving determination step of determining whether the vehicle is coasting;
a fuel-in condition determination step of repeating the coasting driving determination step until a fuel-in condition is met when current revolutions per minute (RPM) of an engine at a time at which it is determined that the vehicle is coasting is at least higher than fuel-in RPM of the engine;
a minimum fuel-in step of performing a minimum fuel-in operation of supplying a minimum controllable unit of fuel when, as a result of a determination at the fuel-in condition determination step, it is determined that the fuel-in condition is met; and
a fuel-in repetition step of repeating the minimum fuel-in step a predetermined reference number of times within a range in which an angular acceleration amplitude increase rate of the engine is not made to exceed a predetermined reference increase rate by the minimum fuel-in operation.

2. The method of claim 1, further comprising:
a fuel-in termination step of after the minimum fuel-in step, terminating the minimum fuel-in operation when the angular acceleration amplitude increase rate of the engine exceeds the predetermined reference increase rate or when the fuel-in repetition step has been performed; and
a creep driving entry step of, after the fuel-in termination step, determining whether an accelerator pedal has been stepped on, and entering a state of creep driving when it is determined that the accelerator pedal has not been stepped on.

3. The method of claim 2, wherein the fuel-in condition determination step is configured to, after performing a fuel-cut determination step of repeatedly determining whether a fuel-cut operation has been performed when the current RPM of the engine exceeds fuel-cut RPM of the engine, repeatedly determine whether the fuel-in condition is met when it is determined that the fuel-cut operation has been performed.

4. The method of claim 3, wherein the creep driving entry step is performed when, it is determined that the current RPM of the engine is equal to or lower than the fuel-in RPM of the engine.

5. The method of claim 4, wherein the method returns to the coasting driving determination step when it is determined at the creep driving entry step that the accelerator pedal has been stepped on.
